(19) United States
(12) Patent Application Publication
(10) Pub. No.: US 2002/0124813 A1
(43) Pub. Date: Sep. 12, 2002

(54) Device for sifting cat littler

(76) Inventor: Derek James Rose, Mansfield, OH (US)

Correspondence Address: Derek J. Rose, 41 Hoffman Avenue, Mansfield, OH, 44906, US

(21) Appl. No.: 10/091,723

(22) Filed: Mar. 6, 2002

Related U.S. Application Data
(60) Provisional application No. 60/274,750, filed on Mar. 12, 2001.

(51) Int. Cl. A01K 23/00

(52) U.S. Cl. 119/867

(57) ABSTRACT

A hand held sifting device is intended for use on any size cat litter box and includes generally parallel, spaced bars, through which litter may be sifted. The width of the sifting portion of the device is sized to fit the largest common cat pans and is easily modified to fit most any smaller size cat pan. Cleaning of smaller sized pans is simplified by sliding the sifter through the soiled litter to remove the solid and clumped waste. Cleaning larger pans is simplified by placing the sifter at one end and lifting the opposite end of the box, while sliding the sifter toward the raised end permitting gravity to sift the litter through the screen. Creation of airborne dust is minimized and hidden waste adhered to the pan beneath the litter is revealed and easily removed.

### CROSS REFERENCE TO RELATED APPLICATIONS

This application is based on provisional application serial No. 60/274,750, filed Mat. 12, 2001, titled Cat Litter Sifting Screen.

### BACKGROUND OF THE INVENTION

This invention relates generally to the field of litter boxes for pets, and more particularly to an article of manufacture for sifting cat litter in a rapid manner.

This application relates to the task of cleaning cat litter boxes. The typical method involves repeated scooping and sifting of the litter, working from one end of the box to the opposite end until all the solid waste and clumped material is removed. This is a time consuming and dirty endeavor. Dust is often breathed in and also gets into ones eyes or deposited on ones eyeglasses or contact lenses. The more scooping required increases the amount of time spent doing an unpleasant task. One is typically required to stoop or kneel to carry out the chore, thus it would be advantageous to those persons with ailing backs, hips or knees to minimize the duration of the task and reduce the amount of discomfort.

There have been numerous proposals made for several types of devices and apparatuses that sift cat litter.

Gershman, U.S. Pat. No. 4,522,150 discloses a cat litter disposal consisting primarily of a rounded top, a removable bottom tray for litter, and a slidably mounted screening drawer. The litter is sifted by rotating the housing 360 degrees along its longitudinal axis, forcing the litter to pour through the screening drawer. The drawer is removed when the box is in its original position, and the solid waste is discarded.

Breault, U.S. Pat. No. 4,667,622 discloses a pet litter box, which is tipped over to one side to separate solid waste from soiled litter and to refill the displaced litter with fresh litter. The box consists of a temporary holding area for fresh litter, a second temporary holding area for soiled litter, and a series of baffles for separating soiled waste. Solid waste is separated from the soiled litter by tipping the box on one end, forcing the litter to pass through baffles. Fresh litter is dispersed by tipping the box to its original position.

Nussle, U.S. Pat. No. 5,167,204 discloses a litter box apparatus that consists primarily of a tray, a screening device, a receptacle and a shutter portion. The box is pivoted to permit the litter to sift through the screen to separate the solid waste, which tumbles into a receptacle for removal by subsequent actuation of the shutter.

Lapps et al., U.S. Pat. No. 5,178,099 discloses a pet privy, which separates solid waste from soiled litter by rotation of the apparatus about a pivotally connected support frame. The system includes the frame, a tray for litter, a hood, a filter grid, a discharge funnel and a disposable bag.

Nunn, U.S. Pat. No. 5,190,326 discloses a litter box cleaner consisting of a hand held container with a spring operated shutter and a slotted shovel. Solid waste is removed by the slotted shovel and enters the container for storage.

Rood, U.S. Pat. No. 5,601,052 discloses a litter box with a substantially large rear wall relative to the front and side walls, and a removable sifting tray with three side walls. The sifting tray is placed in the litter box and later lifted out of the box to sift the soiled litter. The box is subsequently tipped on its rear wall to reinsert the tray in the box, while the sifted litter is temporarily in the rear-wall portion, until box is tipped back to the floor.

Ayle, U.S. Pat. No. 5,673,648 discloses a litter box consisting of a tray with an integral slide-rail type sifting device and a waste chute incorporated into a cover. The apparatus sifts litter by tipping the box toward a rearward located chute, causing the litter to pass through the sifting device and the separated material to slide toward the disposal chute.

Vice et al., U.S. Pat. No. 5,893,336 discloses a litter box with a sifter insert in which the sifting device has a foraminous bottom wall, three sidewalls and an angled leading edge. The sifting device is designed to slide freely and fit snugly in the litter box with the foraminous bottom wall placed on the bottom wall of the litter box. The sifter insert is forced through the litter to separate the solid waste without the need to transfer the litter to another container.

Other devices permit the sifting of litter by transferring or pouring the contents of the litter container through a screening device and into a second container, or by lifting a screening device through the litter, then transferring the litter to a second container. These are usually fast methods but the high amount of litter movement involved with these processes generate significant amounts of dust. Some devices involve rotating or tumbling the litter box to sift the litter. These are typically fast methods as well, however they often are not efficient at removing soiled litter since coagulated litter often becomes adhered to the sides and bottom of the pan. The waste that has adhered to the pan is often not visible since these tilting or tumbling devices and methods generally require a cover, thus the adhered waste remains unseen and is not removed, leaving an unsanitary condition. Many existing litter-sifting systems include numerous components or require sifting devices that are designed or configured to be used exclusively with a particular litter pan or system. An increasing number of households own multiple cats, which require multiple litter pans. Many of these households cannot afford to purchase the multiple pans required with each pan typically having dedicated sifting devices. The typical individual litter scoops, sifting spoons and baskets are inexpensive and a popular choice of many pet owners, however, these utensils are messy, slow and often create dust that becomes inhaled by the user.

### BRIEF SUMMARY OF THE INVENTION

The primary object of the invention is to provide an improved device for simplifying the sifting of solid waste and clumped cat litter from soiled cat litter.

Another object of the invention is to provide a device that significantly reduces the amount of time required to sift cat litter.

Another object of the invention is to provide a universal device with an extra wide screen in which the width is easily adjusted to fit most cat pan sizes.

A further object of the invention is to provide means to sift cat litter with one pass of the device through the pan, thus significantly reducing the time required to sift litter.

Yet another object of the invention is a method that reduces the amount of airborne dust potentially inhaled by reducing the amount of sifting required.

Still yet another object of the invention is a means to reduce potential stress on the lower back and knees by minimizing the amount of awkward kneeling or stooping.

Another object of the invention is a means to sift litter without transferring litter to another pan or container.

Another object of the invention is to provide a lower cost device for rapidly removing solid and clumped waste from cat litter.

In accordance with a preferred embodiment of the present invention, a device for sifting cat litter comprises a sifting portion configured generally as an array of parallel bar members, said parallel bar members each being supported in spaced relationship in the form of at least two series of support bars, positioned generally perpendicular to aforementioned parallel bar members and placed along the general proximity of the end regions of said parallel bar members, with said support bars providing means to readily modify the length of said sifting portion, said length of aforementioned sifting portion is of substantial size such that each end is contiguous and slidable in relation to the base of peripheral walls of a given litter container, with said length of said sifting portion aligned parallel to an interior width of the larger sized common commercially available cat litter pans; a stiffening means juxtaposed within the central area of said sifting portion in the form of at least one rib and generally parallel to aforementioned bar members; and a handle to manipulate said sifting portion.

In accordance with another preferred embodiment of the present invention, a device for sifting cat litter with a means to vary the width of the sifting portion for use on a wide range of pan sizes, such that a pet owner can use the invention with the pet owner's existing litter pan. The device enables the separation of soiled waste from clumping type litter in a fast manner with one pass of the sifting device through the litter box. The invention is a low cost device to rapidly remove solid and clumped waste from litter boxes. The new device is especially beneficial to households with multiple cats by saving both time and cost, since most multiple-cat households have more than one litter pan and a singular sifting device in the form of the invention will function with a plurality of litter pans.

Other objects and advantages will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a sifter configured as described in accordance with the present application.

FIG. 2 is a side plan view of the sifter.

FIG. 3 is a front plan view of an alternate embodiment.

FIG. 4 is an isometric view of an alternate embodiment.

FIG. 5 is an assembled isometric view of an alternate embodiment.

FIG. 6 is a front plan view of the sifter demonstrating a typical method to modify the size of the sifter.

FIG. 7 is a longitudinal cross section through a typical litter box showing the box being lifted at one end.

FIG. 8 is a longitudinal cross section through a typical litter box showing the sifter being positioned in a litter box.

FIG. 9 is a longitudinal cross section through a typical litter box showing a litter box raised at one end and the soiled litter being separated from the sifted litter.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

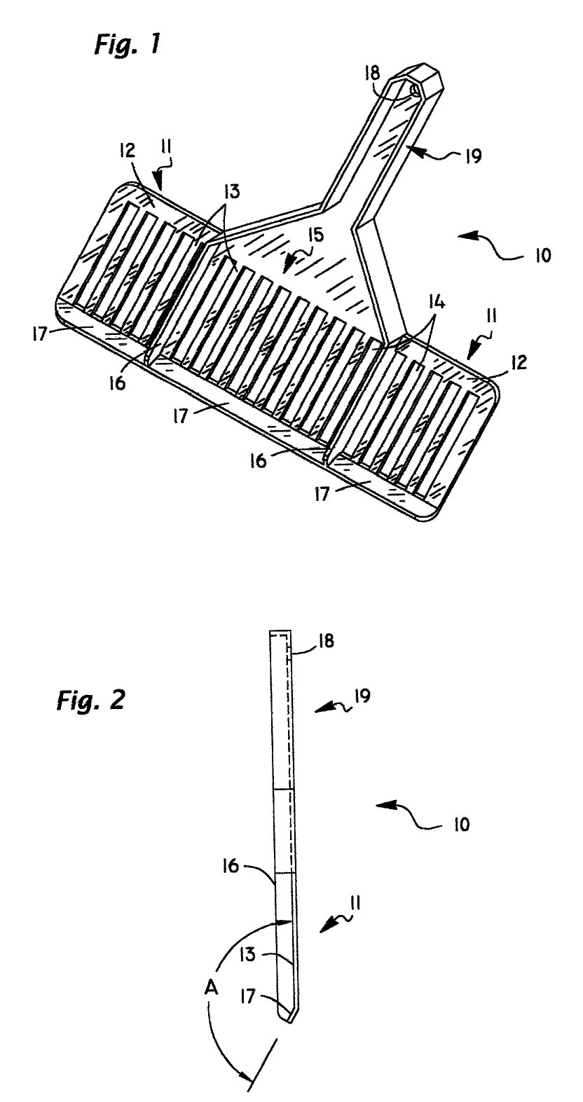

Referring now to the drawings and to FIG. 1 particularly, a preferred configuration of a litter sifting device 10 is shown constructed in accordance with the present application. The sifting device 10 is preferably molded in one piece from polypropylene, polyethylene, polyvinyl chloride or other plastic of suitable strength.

FIG. 1 shows a sifting portion consisting of three generalized areas, including interior positioned sifting area 15 and two exterior sifting areas 11 located on either side of the interior sifting area 15. The total sifting area is configured generally in the form of an array of parallel bar members 13 and held in spaced relationship by at least two series of support bars 11 and 17 placed at the end portions of the parallel bar members 13. The passages 14 formed by the spacing of parallel bar members 13 and adjacent to same, permit loose litter material to pass freely.

Two stiffening ribs 16 separate sifting area 15 from sifting areas 11 and are generally but not exclusively parallel to bar members 13 and serve to increase rigidity of the sifting areas 11 and 15. The stiffening ribs 16 are preferably located centrally on device 10 in the general region represented by interior sifting area 15 and generally bounded by sifting areas 11, to permit removal of bar members 13 in exterior sifting areas 11 without sacrificing stiffness.

A handle area 19 to manipulate device 10 without contacting soiled litter, may include extensions of stiffening ribs 16 for rigidity and an aperture 19 for hanging device 10 for display or storage.

The preferred embodiment, as seen in FIGS. 1 and 2, includes having support bar 17 angled relative to the parallel bar members 13 to form an obtuse angle A between the intersecting planes of support bar 17 and parallel bar members 13. The support bar 17 serves as a retaining lip to assure solid waste remains contained within device 10 until disposal.

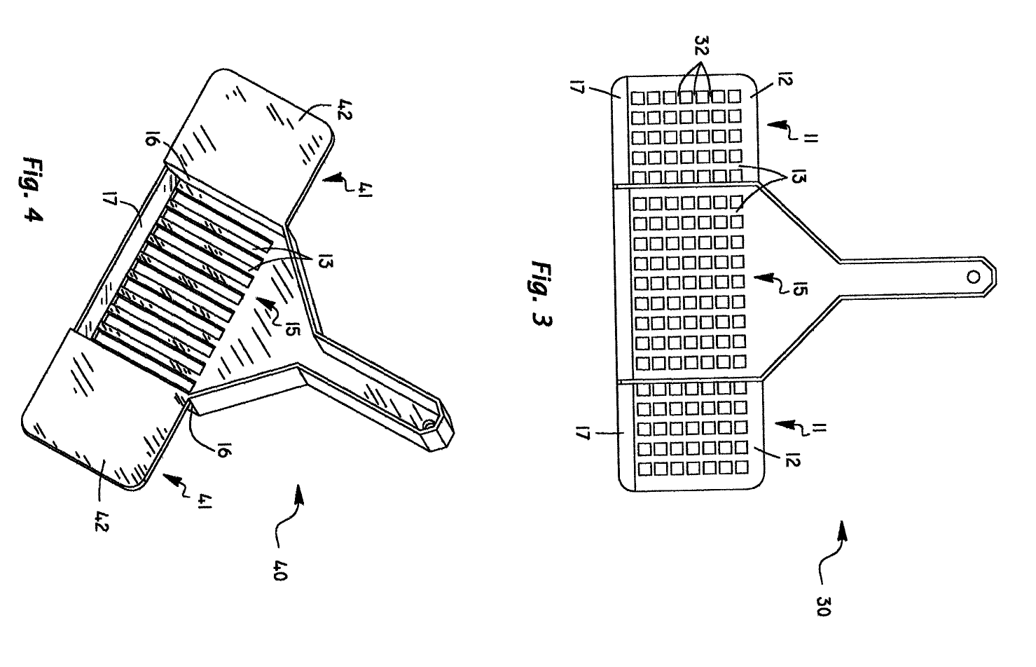

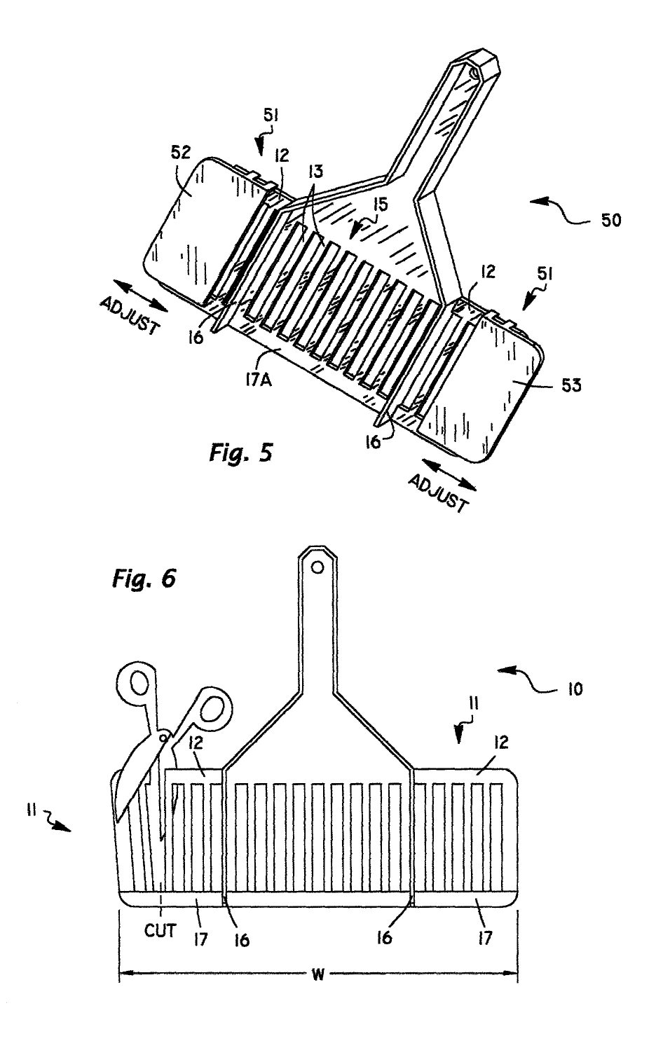

FIGS. 3, 4 and 5 show alternate configurations 30, 40 and 50 respectively, wherein similar items are numbered similarly. Referring first to FIG. 3, additional support bars 32 in conjunction with bar members 13 form generally reticulated areas 11 and 15. FIG. 4 illustrates two obstructive guides 42 on each flank of sifting area 15 formed by two generally flat and imperforate walls, which prevent the passage of litter except through the central sifting area 15. The two obstructive guides 42 can have material removed by cutting to reduce the size of the device 40 to fit when inserted within a given size litter pan. FIG. 5 shows the addition of two removably assembled obstructive guides 52 and 53. In this configuration, the obstructive guides 52 and 53 are generally flat and imperforate and may clamp or snap onto the exterior sifting areas 51 and are adjustable in position relative to the overall width of device 50. The obstructive guides 52 and 53 are preferably made from the same material as device 10. An alternate version of the support bar 17A is shown having the same plane as parallel bar members 13.

Referring now to FIG. 6, the length L of sifting device 10 is of substantial size such that each end of length L is contiguous and slidable in relation to the base of the peripheral walls of the larger size commercially available cat litter pans, when device 10 is inserted such that support bar 17 is in contact with the bottom of the pan and the longitudinal axis of length L is aligned parallel with the interior width of the pan. Length L can be modified to fit the smaller size litter pans by cutting through support bars 12 and 17, in order to remove one or more of parallel bar members 13, located in one or both of the two exterior sifting areas 11, as appropriate for achieving a suitable fit. Alternately, device 50 shown in FIG. 5 may have the length modified by sliding or positioning, and attaching by clamping, clipping, or fastening by means of a snap-fit type configuration, guides 52 and 53 to a position within the two general flank areas 51 on device 50 as appropriate for the particular size of a given litter pan.

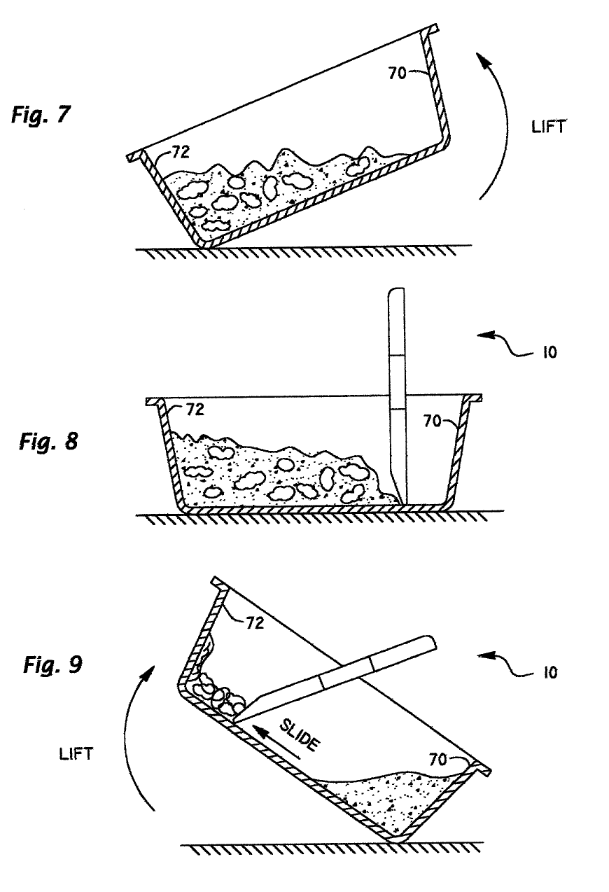

There are several methods of use for the invention. The initial step for one typical method is shown in FIG. 7, in which a litter pan is lifted at end 70 such that the soiled litter flows to the opposite lower end 72, leaving a small section of the bottom of the pan adjacent to end 70 exposed. FIG. 8 shows pan end 70 placed back at floor level, with sifting device 10 inserted in the region of the exposed pan bottom adjacent to end 70. FIG. 9 shows how opposite end 72 of the pan is then raised allowing soiled litter to flow towards sifting device 10, while simultaneously sliding sifting device 10 across the bottom of the pan towards end 72. The solid and clumped waste is separated and their transit obstructed by the invention, while un-clumped waste is passed readily through device 10 to collect at end 70 of the pan. Very little dust is generated since the litter is not raised from the pan and allowed to fall back into the pan as is often the case with other sifting devices. Pan end 70 is then returned to the floor and the separated waste is discarded.

Another typical method of use, which is practical for smaller sized pans, involves simply inserting device 10 into one end of a typical litter pan and moving the device through the litter, such that device 10 traverses the pan bottom to the opposite end to remove the solid waste from the pan with one pass through the litter.

The present invention includes all modifications and variations of the preferred embodiments that may become apparent to those skilled in the art after reading and understanding this description, and the full scope of this invention is determined only by the limits established in the claims.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A device for sifting cat litter comprising:
a sifting portion configured generally as an array of parallel bar members, said parallel bar members each being supported in spaced relationship in the form of at least two series of support bars, positioned generally perpendicular to aforementioned parallel bar members and placed along the general proximity of the end regions of said parallel bar members, with said support bars providing means to readily modify the length of said sifting portion, said length of aforementioned sifting portion is of substantial size such that each end is contiguous and slidable in relation to the base of peripheral walls of a given litter container, with said length of said sifting portion aligned parallel to an interior width of the larger sized common commercially available cat litter pans,
a stiffening means juxtaposed within the central area of said sifting portion in the form of at least one rib and generally parallel to aforementioned bar members, and
a handle to manipulate said sifting portion.

2. A device for sifting cat litter as claimed in claim 1 wherein said sifting portion is readily changeable for use with a variety of pan sizes by cutting said support bars to remove said parallel bar members, such that said length of said sifting portion fits snugly and is slidably engaged in relation to the base of the peripheral walls, with said length of said sifting portion aligned parallel to the width of a given size litter pan.

3. A device for sifting cat litter as claimed in claim 2 further comprising additional support bars parallel to said support bars such that the sifting portion is generally reticulated.

4. A device for sifting cat litter as claimed in claim 1 wherein said side wall portions are slidably attached to said support bars utilizing the apertures between said parallel bar members as detents to adjust a shield in a position that effectively modifies the length of said sifting portion to fit snugly and slidably with the interior width of a given litter pan.

5. A device for sifting cat litter comprising:
a sifting portion configured generally as an array of parallel bar members, said parallel bar members each being supported in spaced relationship in the form of at least two series of support bars, positioned generally perpendicular to aforementioned parallel bar members and placed along the general proximity of the end regions of said parallel bar members,
a stiffening means juxtaposed within the central area of said sifting portion in the form of at least one rib and generally parallel to aforementioned bar members,
an imperforate and generally flat side wall portion at one or each end of said sifting portion, wherein the overall length of said sifting device is readily changeable for use with a variety of pan sizes, by cutting said side wall portion(s) to remove material accordingly, such that said length of said sifting device fits snugly and is slidably engaged in relation to the base of the peripheral walls, with said length of said sifting device aligned parallel to the width of a given size litter pan, and
a handle to manipulate said sifting portion.
